(19) United States
(12) Patent Application Publication
(10) Pub. No.: US 2007/0022611 A1
(43) Pub. Date: Feb. 1, 2007

(54) PORTABLE SLICER FOR FOOD PRODUCTS

(76) Inventor: Stacy Verbiest, Manhattan Beach, CA (US)

Correspondence Address: IPLA P.A., 3580 WILSHIRE BLVD., 17TH FLOOR, LOS ANGELES, CA, 90010, US

(21) Appl. No.: 11/460,952

(22) Filed: Jul. 28, 2006

Related U.S. Application Data
(60) Provisional application No. 60/702,844, filed on Jul. 28, 2005.

(51) Int. Cl. A21C 15/04

(52) U.S. Cl. 30/114

(57) ABSTRACT

Disclosed is a portable slicer for food products comprising a base having an upper surface defined by an elongate seat and a circumferential edge, the upper surface being selectively, longitudinally recessed to form the elongate seat lowered from and surrounded by the edge, the upper surface being vertically spaced apart to form a plurality of channels in lengthwise columns and widthwise rows. A frame is foldably connected to the base, the frame having one or more blades aligned to fit in the channels.

### CROSS-REFERENCE TO RELATED APPLICATIONS

This application claims priority benefit under 35 U.S.C. 119 (e) of Provisional Patent Application Ser. No. 60/702,844 entitled “Hot Dog Slicer” filed on Jul. 28, 2005, and incorporates all of its disclosure by reference.

### BACKGROUND OF THE INVENTION

The present invention relates to a cutlery device and, more particularly, to an innovatively improved portable slicer for food products such as hot dogs, enabling a single stroke to make a neat slicing of, for example, just-cooked dogs to pieces edible instantly by any aficionados including children.

An average American is known to gulp down more than 80 hot dogs per year. Whether engulfed while watching a baseball game, enjoyed as an after school snack, or offered along with juicy burgers at a barbecue, the delicious hot dog is a versatile food that can be enjoyed at practically any time of day. The frankfurter itself without the bun would probably be one of the favorite foods of young children. Kids delight in grasping the oblong meat product, swirling it around in a mound of ketchup, and bobbling up the tasty and easy-to-eat food. Unfortunately, the hot dog is also among the top ten items found in many lists concerning choking occurrences in young children. To prevent the chances of choking on a frankfurter during consumption, parents typically slice the hot dog into small, bite-size pieces or into linear strips. While paring down a frankfurter makes it safer for children to eat. Slicing the meat can present a couple of drawbacks. Particularly, holding on to a just-cooked dog while trying to slice it can result in painful burns on the fingers. In addition, wielding a sharp knife to cut the weenie into small pieces can lead to nicks and cuts on the hand. Ironically a hot dog safer for consumption can be a bit dangerous. A demand on the market is a hot dog slicing device that is safe, portable, easy to use and machine washable as one presented by this inventor.

### SUMMARY OF THE INVENTION

The present invention is contrived to overcome the conventional disadvantages. Accordingly, an objective of the present invention is to provide a portable slicer for food products that enables a single stroke to make a neat slicing of, for example, just-cooked dogs to pieces edible instantly by any aficionados including children.

Another objective is to provide a portable slicer for food products that enables quick and efficient slicing of a frankfurter in a relatively hands-free manner.

A further objective is to provide a portable slicer for food products, which realizes ultimate goals of a food slicing device, i.e., knife-free safety, quick slicing, easy to use and machine washable conveniences.

To achieve these and other objectives, A slicer for food comprises a base having an upper surface defined by an elongate seat and a circumferential edge, the upper surface being selectively, longitudinally recessed to form the elongate seat lowered from and surrounded by the edge, the upper surface being vertically spaced apart to form a plurality of channels in lengthwise columns and widthwise rows; and a frame foldably connected to the base, the frame having one or more blades aligned to fit in the channels. One of the column channels is preferably formed along a lengthwise central line of the elongate seat. The blades may be formed of stainless steel wires. The foldable connection is a hinge connection. Further comprised is a handle connected to the frame to oppose the foldable connection, and a support attached to an outer periphery of the base to hold thereon the frame when the frame is lowered into the base for food slicing. Here, the upper surface is formed in protrusion from the support. For a better performance the slicer may be formed to a substantial portable size to range about five to ten inches in length, two to four inches in width, and one to three inches in height.

In an embodiment, the slicer for food products comprises the base having an upper surface defined by an elongate seat and a circumferential edge, the upper surface being selectively, longitudinally recessed to form the elongate seat lowered from and surrounded by the edge, the upper surface being vertically spaced apart to form a plurality of channels in lengthwise columns and widthwise rows; a first frame foldably connected to the base, the first frame having one or more blades aligned to fit in the columned channels; and a second frame foldably connected to the base, the second frame having one or more blades aligned to fit in the rowed channels.

A third frame may be connected to the base, where the third frame has a single blade aligned to fit in one of the columned channels, and the frames are sequentially aligned so that the third frame remains closer to the base than the other frames. The single blade of the third frame is formed to fit in one of the column channels formed along a lengthwise central line of the elongate seat. The handle connected to each of the frames may be formed to oppose the foldable connection. The base and the frames are each shaped in an ovally oblong format when viewed atop. To realize portability the slicer may be formed to a substantial portable size to range about five to ten inches in length, two to four inches in width, and one to three inches in height.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a food slicer according to an embodiment of the present invention;

FIG. 2 is a construction view of the food slicer in an after-slicing mode;

FIG. 3 is a cross-sectional view taken along III-III in FIG. 2;

FIG. 4 is a cross-sectional view taken along IV-IV in FIG. 2; and

FIG. 5 is a perspective view of the food slicer according to another embodiment of the present invention.

### DETAILED DESCRIPTION OF THE PREFERRED EMBODIMENTS

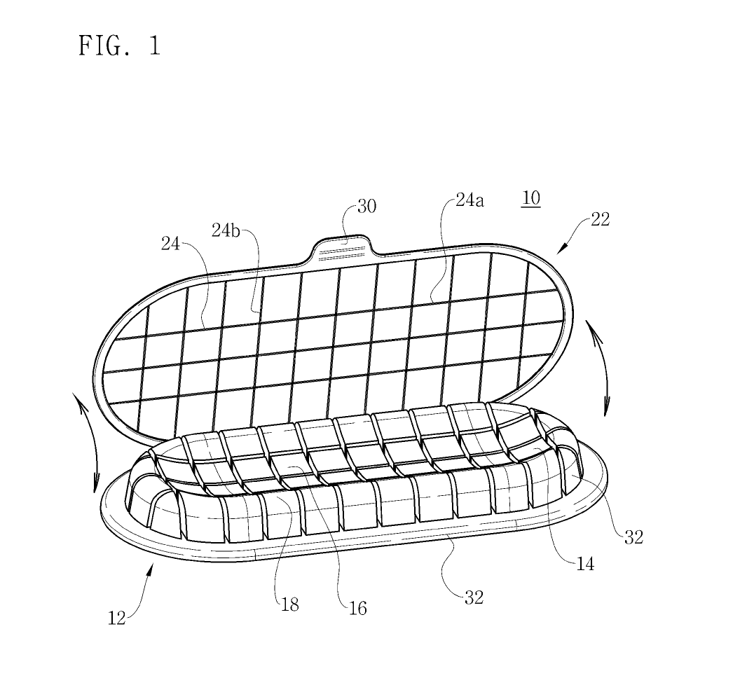

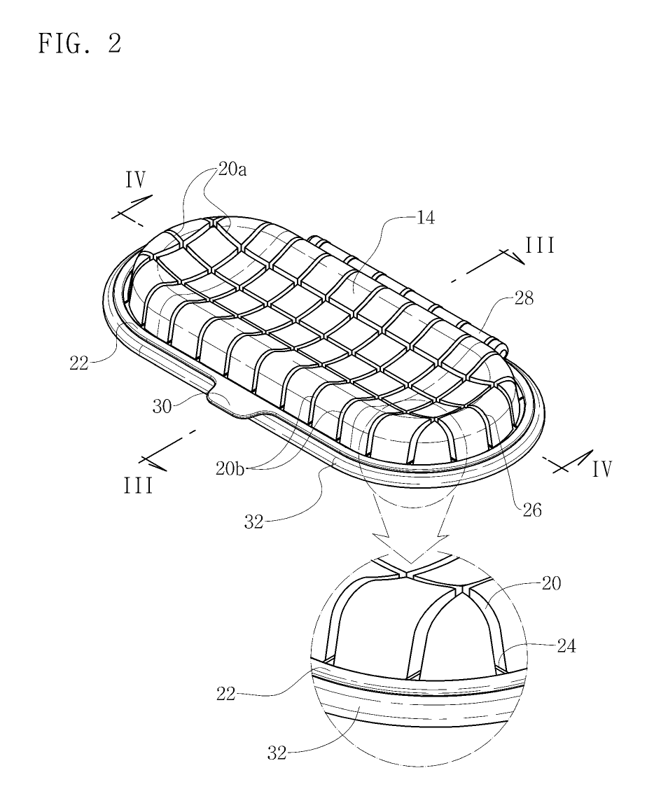

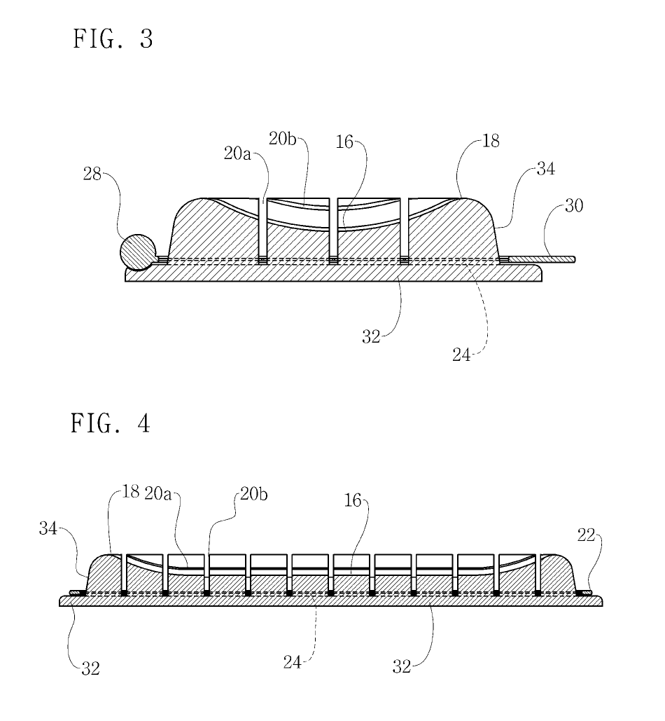

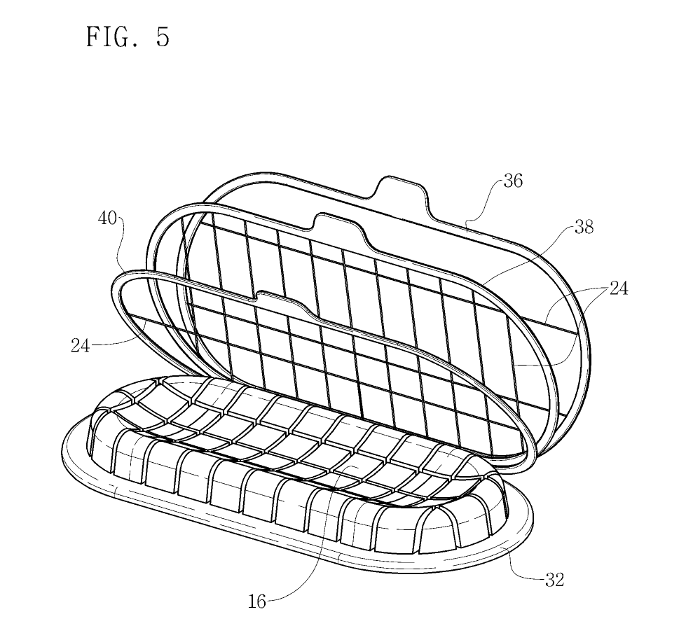

FIG. 1 shows a portable slicer 10 for food products serving also as a hot dog slicer according to a preferred embodiment. FIG. 2 shows the slider 10 in an after-slicing mode with an enlargement view detailing the construction of the slicer 10. FIGS. 3 and 4 are cross-sections further detailing construction of the slicer 10. FIG. 5 shows a second embodiment of the present invention.

As shown in FIGS. 1 to 4, the slicer 10 comprises a base 12 having an upper surface 14 defined by an elongate seat 16 and a circumferential edge 18. The upper surface 14 is selectively, longitudinally recessed to form the elongate seat 16 lowered from and surrounded by the edge 18. The upper surface 14 is vertically spaced apart to form a plurality of channels 20 in lengthwise columns 20a and widthwise rows 20b. The slicer 10 also comprises a frame 22 is foldably connected to the base 12. The frame is provided to include one or more blades 24 aligned to fit in the channels 20.

The slicer 10 is basically formed in a two-part assembly of the base 12 and the frame 22 with a foldable connection therebetween. The connection is preferably realized by a hinge 28. This construction enables a user to make an easy single stroke action of the frame 22 down into the base 12 having the elongate seat 16 along its upper surface 14. For example, when a frankfurter (not shown) is placed on the elongate seat 16 for slicing and the frame 22 is lowered with a downward motion against the base 12, the blades 24 of the frame 22 will cut into the meat, slicing it into desired smaller pieces and then sequentially travel along and land in the channels 20 of the base 12. Such instant slicing of the hot dog on the seat 16 to bite-size pieces would attribute to the recessed seat 16 formed by cutout molding of the upper surface 14. The circumferential edge 18 surrounding the elongate seat 16 serves to safely contain the meat within the elongate seat 16.

For cleaning and maintenance purposes, the base 12 may be formed of a plastic material that allows dishwasher for cleaning or simple scrubbing using general detergent. Meanwhile, the blades 24 are preferably formed of stainless steel. Selectively, the blades 24 may be wires formed of stainless steel.

In a preferred mode, the upper surface 14 including the elongate seat 16 and the edge 18 is evenly and vertically spaced apart to form evenly spaced channels 20 aligned in lengthwise columns 20a and widthwise rows 20b. Here, the column channels 20a is formed along a lengthwise central line 26 of the elongate seat 16 to facilitate a lateral slicing when required. Further, the combination of lengthwise columns 20a and widthwise rows 20b determines layout of the blades 24. It is also recommended that the channels 20 each have two to three times wider width than the width of each blade 24 for smoother accommodation of the blades 24 therein.

In order to facilitate the lowering of the frame 22 down against the base 12, a handle 30 is selectively connected to the frame 22 to oppose the foldable connection. Namely, the handle 30 is preferably disposed on an opposite side of the hinge 28.

For a better performance, a support 32 is attached to an outer periphery 34 of the base 12 to hold thereon the frame 22 when the frame 22 is lowered into the base 12 for food slicing. In this construction, the upper surface 14 is formed in protrusion from the support 32. Here, the support 32 can be formed of the same material as the base 12. To improve portability and product safety, the base 12 and the frames 22 are each shaped in an ovally oblong format when viewed atop. That is, the slicer 10 in an elongate format carries an oblong shape in oval.

To facilitate storage and carriage, the slicer 10 may be formed in compact and lightweight design. For this purpose it is recommended that the slicer 10 is formed to a substantial portable size to range about five to ten inches in length, two to four inches in width, and one to three inches in height.

In another embodiment, the slicer 10 comprises the base 12 and first to third frames 36, 38, 40 foldably each connected to the base 12. In this construction, the first frame includes one or more blades 24a aligned to fit in the columned channels 20a. The second frame 38 includes one or more blades 24b aligned to fit in the rowed channels 20b. The third frame 40 includes a single blade 24a aligned to fit in one of the columned channels 20a. In this construction, the frames 36, 38, 40 are sequentially aligned so that the third frame 40 remains closer to the base 12 than the other frames 36, 38. Here, the single blade 24a of the third frame 38 is formed to fit in one of the column channels 20a formed along the lengthwise central line 26 of the elongate seat 16. The handle 30 may be connected to each of the frames 36, 38, 40 to oppose the foldable connection. Also, the support 32 is attached to an outer periphery 34 of the base to sequentially hold thereon the frames 36, 38, 40 when the frames are selectively lowered into the base 12 in a manner in which the blades 24 are lowered to become seated in corresponding channels 20, during which the meat (not shown) placed on the elongate seat 16 of the upper surface 14 will be sliced to smaller uniform pieces like bite-size square-shape chunks.

As discussed above, an advantage is that the portable slicer 10 for food products enables a single stroke to make a neat slicing of frankfurter or other food products to smaller pieces edible instantly by any aficionados including children. The slicer 10 also enables quick and efficient slicing of a frankfurter in a relatively hands-free manner while realizing ultimate goals of an invaluable accessory for any kitchen, i.e., knife-free safety, easy to use and machine washable conveniences.

Although the invention has been described in considerable detail with reference to certain preferred versions thereof, other versions are possible by converting the aforementioned construction. For example, the capacity of the slicer 10 enabling expedient slicing of food products is applicable to restaurants, catering companies and even school cafeterias in addition to household use. Therefore, the scope of the invention shall not be limited by the specification specified above and the appended claims.

What is claimed is:

1. A portable slicer for food products, comprising:
a base having an upper surface defined by an elongate seat and a circumferential edge, the upper surface being selectively, longitudinally recessed to form the elongate seat lowered from and surrounded by the edge, the upper surface being vertically spaced apart to form a plurality of channels in lengthwise columns and widthwise rows; and
a frame foldably connected to the base, the frame having one or more blades aligned to fit in the channels.

2. The slicer of claim 1, wherein one of the column channels is formed along a lengthwise central line of the elongate seat.

3. The slicer of claim 1, wherein the blades are formed of stainless steel.

4. The slicer of claim 1, wherein the blades are stainless steel wires.

5. The slicer of claim 1, wherein the foldable connection is a hinge connection.

6. The slicer of claim 1, further comprising a handle connected to the frame to oppose the foldable connection.

7. The slicer of claim 1, further comprising a support attached to an outer periphery of the base to hold thereon the frame when the frame is lowered into the base for food slicing.

8. The slicer of claim 7, wherein the upper surface is formed in protrusion from the support.

9. The slicer of claim 1, wherein the slicer is formed to a substantial portable size to range about five to ten inches in length, two to four inches in width, and one to three inches in height.

10. A portable slicer for food products, comprising:
a base having an upper surface defined by an elongate seat and a circumferential edge, the upper surface being selectively, longitudinally recessed to form the elongate seat lowered from and surrounded by the edge, the upper surface being vertically spaced apart to form a plurality of channels in lengthwise columns and widthwise rows;
a first frame foldably connected to the base, the first frame having one or more blades aligned to fit in the columned channels; and
a second frame foldably connected to the base, the second frame having one or more blades aligned to fit in the rowed channels.

11. The slider of claim 10, further comprising a third frame connected to the base, the third frame having a single blade aligned to fit in one of the columned channels, wherein the frames are sequentially aligned so that the third frame remains closer to the base than the other frames.

12. The slicer of claim 11, wherein the single blade of the third frame is formed to fit in one of the column channels formed along a lengthwise central line of the elongate seat.

13. The slicer of claim 10, wherein the blades are formed of stainless steel.

14. The slicer of claim 10, wherein the blades are stainless steel wires.

15. The slicer of claim 10, wherein the foldable connection is a hinge connection.

16. The slicer of claim 10, further comprising a handle connected to each of the frames to oppose the foldable connection.

17. The slicer of claim 10, further comprising a support attached to an outer periphery of the base to hold thereon the frames when the frames are selectively lowered into the base for food slicing.

18. The slicer of claim 10, wherein the upper surface is formed in protrusion from the support.

19. The slicer of claim 10, wherein the base and the frames are each shaped in an ovally oblong format when viewed atop.

20. The slicer of claim 10, wherein the slicer is formed to a substantial portable size to range about five to ten inches in length, two to four inches in width, and one to three inches in height.
